(19) United States
(12) Patent Application Publication
(10) Pub. No.: US 2014/0278630 A1
(43) Pub. Date: Sep. 18, 2014

(54) SYSTEM AND METHOD FOR WASTE MATERIAL MANAGMENT

(71) Applicant: Compology, Inc., San Francisco, CA (US)

(72) Inventors: Jason Skylar Gates, San Francisco, CA (US); Benjamin Chehebar, San Francisco, CA (US)

(73) Assignee: Compology, Inc., San Francisco, CA (US)

(21) Appl. No.: 14/211,709

(22) Filed: Mar. 14, 2014

Related U.S. Application Data
(60) Provisional application No. 61/801,021, filed on Mar. 15, 2013.

(51) Int. Cl. G06Q 10/06

(52) U.S. Cl. CPC G06Q 10/0631
USPC 705/7.13

(57) ABSTRACT

A method for scheduling waste material removal, comprising: receiving waste material information for each of a set of containers, each container comprising a sensor and configured to contain waste material, the waste material information based on a sensor measurement by the sensor, identifying contents of the waste material contained within each of the set of containers based on the respective waste material information, and determining a collection schedule for the set of containers based on the contents of the waste material for each of the set of containers.

### CROSS-REFERENCE TO RELATED APPLICATIONS

This application claims the benefit of U.S. Provisional Application No. 61/801,021 filed 15 Mar. 2013, which is incorporated in its entirety by this reference.

### TECHNICAL FIELD

This invention relates generally to waste material management field, and more specifically to a new and useful method and system for managing and transmitting waste material data in the waste material management field. In particular, this invention provides a new and useful system for monitoring of containers such as dumpsters for organic waste that is biodegradable as well as for handling liquid waste such as waste cooking oil that can be recycled. The system and method also facilitates collection and waste disposal service route arrangement, specifically for optimizing removal or replenishment routes and increasing security.

### BACKGROUND

Removal and replenishment services are used in many industries for the purpose of taking away or adding a material that has been or will be used in a process. More specifically, waste and commodity haulers have complex truck routing requirements based on their own schedules or based on customer demands or needs.

Traditional waste collection services are based on pickups on a particular day or time. While this enables the haulers to efficiently schedule trucks and manpower for waste pickup, it does not address the needs of the parties that are creating the waste material. Thus, pickups can be of whatever waste the consumer has made. This is often partially filled containers when only a small amount of waste is generated between pickups. A more serious problem occurs when the consumer generates more waste that the containers can hold between the pickups.

Haulers must estimate when a waste or commodity storage container requires emptying or replenishment. This leads to two problems: haulers' pickup schedules are inefficient because they are picking up less-than-full storage containers and they frequently need to provide on-call pickups/deliveries of overfilled or empty storage containers. Inefficient pickup schedules result in financial losses and potentially poor customer service perception. To optimize hauling routes, haulers need real-time data of the levels of waste or commodity they are hauling that can be accessed remotely.

Haulers also need a way to mitigate odors from materials such as decomposing food waste to enable more efficient pickup schedules while maintaining conformance with hygiene regulations. Additionally, haulers can benefit from increased security of their assets to prevent unauthorized addition or removal of materials, such as waste restaurant grease, to maximize profitability.

Various prior art documents discuss the monitoring of solid or liquid waste containers. U.S. Pat. No. 7,423,541 discloses a tank level monitoring system capable of automatically detecting excessive product usage from the tank wherein the system is capable of monitoring a level of product in a tank using a monitor. Communications from and with a monitor can be via wireless radio frequency communications, cellular, satellite, or the like.

Thus, there is a need in the waste management field to create a new and useful system and method for waste removal scheduling and routing in the waste management field.

### BRIEF DESCRIPTION OF THE FIGURES

FIG. 1 is a representation of an embodiment of the invention;

FIG. 2 is a variation of the embodiment of the invention in FIG. 1;

FIG. 3 is an alternative representation of the variation in FIG. 2;

FIG. 4 is cross-sectional view of the variation of FIG. 2, taken along Plane A of FIG. 2 and viewed toward the opening of the variation;

FIG. 5 is a further embodiment of the invention;

FIG. 6 is a variation of the embodiment of the invention in FIG. 5;

FIG. 7 is a further embodiment of the invention;

FIG. 8 is a variation of the embodiment of the invention in FIG. 7;

FIG. 9 is an alternative representation of the variation in FIG. 8;

FIG. 10 is cross-sectional view of the variation of FIG. 8, taken along Plane A of FIG. 8 and viewed toward the opening of the variation;

FIG. 11 is a flowchart of an embodiment of the method for acquiring and managing waste material data;

FIG. 12 is a variation of the embodiment in FIG. 11;

FIG. 13 is a detailed flowchart of a cycle of waste material data processing for waste management;

FIG. 14 is a flowchart of an embodiment of the systems for acquiring and transmitting waste material data;

FIG. 15 is a broad view flowchart an embodiment of the system in FIG. 14;

FIG. 16 is an exploded of an embodiment of the invention;

FIG. 17 is a side view of an embodiment of the invention in FIG. 16; and

FIG. 18 is a detailed flowchart of the connectivity between components of the embodiment in FIG. 16.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

The method for scheduling waste material removal includes receiving waste material information for each of a set of containers, each container comprising a sensor and configured to contain waste material, the waste material information based on a sensor measurement by the sensor S416; identifying contents of the waste material contained within each of the set of containers based on the respective waste material information S430; and determining a collection schedule for the set of containers based on the contents of the waste material for each of the set of containers S440.

This method functions to determine an optimal or close to optimal waste removal route for a waste disposal service. This method does so by selecting a waste removal route that minimizes cost and maximizes the waste material value (e.g., monetary value, alternatively any other suitable value) to the service. This method can minimize cost by scheduling waste removal when an enclosure is full or near filled (e.g., has a waste material volume exceeding a threshold volume). This method can additionally minimize cost by scheduling waste removal vehicles to minimize queuing at disposal facilities. This method can additionally maximize value by determining the content of the waste material (e.g., whether the waste material in the container contains recyclables, compostables, landfill, e-waste, etc.) or the quality of the waste material (e.g., the contamination level a given type of the waste material or content of waste material, the amount of content mixing in the waste material, etc.). The content or quality of the waste material is preferably determined from optical data of the waste material (e.g., images), but can alternatively be determined from the properties of the waste material, including the density, pH, or temperature. This can determine more accurately the value of the waste material based upon such properties, such as the quality and content of the material, to determine a collection schedule, select a vehicle for a subset of containers, select a destination (e.g., recycling plant, composting plant, or landfill) for a subset of containers, or to make any other suitable decision, such as to determine a billing charge. It also can allow the collector or waste hauler to identify waste materials for collection that have similar properties so that like materials can be collected together, thus avoiding additional purification steps or similar processing operations that would be required for mixed waste materials.

In the description that follows, the term “waste material” is intended to include materials that are waste byproducts for disposal or recycling. Certain waste materials have no value and the waste generator must pay someone to dispose of the material. Certain waste materials, such as waste cooking oil, does have value such that the waste oil generator provides the waste oil at low cost or even at a predetermined cost to the collector. All such waste materials are contemplated by the present invention.

The invention includes numerous embodiments of monitored containers for waste organic materials which may be in solid form, liquid form or combinations thereof. The components for measuring the fill level of the containers thus depends upon the types of waste organic materials placed therein.

In an embodiment, the container is a dumpster for organic waste comprising a receptacle capable of containing the waste; a weight sensor coupled to the receptacle, wherein the weight sensor measures changes, and total, weight of material contained in the receptacle; a pump coupled to the weight sensor, wherein the pump is activated by a change in weight of material contained in the receptacle, wherein the activity level of the pump is directly proportional to the change in weight of the receptacle and the waste the receptacle contains in a linear relationship; and a reservoir capable of containing a fluid including a microorganism capable of fermentation coupled to the pump, wherein activation of the pump results in distribution of the fluid including a microorganism capable of fermentation from the reservoir onto the material contained in the receptacle.

In this device, the pump may be is battery or solar powered to reduce operating costs. The weight sensor may be a piezoelectric sensor. Also, the containment device may further comprise a volume sensor coupled to the reservoir, wherein the volume sensor indicates the volume of the fluid present in the reservoir.

The device generally includes a sealable lid capable of being in an open or closed state with a sensor coupled to the lid that signals to the weight sensor whether the lid is in the open or closed state. Thus, the weight sensor can activate the pump in response to a change in the weight of the receptacle and the waste the receptacle contains when the lid sensor indicates the lid has changed from the open to the closed state.

A microcontroller can be coupled to all sensor(s) and activators, wherein the microcontroller uses an algorithm to aggregate data from said devices; and a transmission device can be provided to communicate information from the microcontroller via a wireless network, wherein the information communicated by the device indicates the volume of waste the receptacle contains.

A preferred volume sensor is one that uses ultrasound to determine the volume of waste the receptacle contains, but it is also possible to use one that includes optics. The transmission device preferably communicates information to a waste disposal service to indicate when the receptacle will be ready to be emptied. This information is utilized by the waste disposal service to determine a collection route for its waste collection vehicles.

The containment device can also include means for distributing fluid to the receptacle coupled to the reservoir, wherein the means of distributing the fluid is activated by a change in the weight of the receptacle and the waste the receptacle contains, wherein the activity level of the means of distributing the fluid is directly proportional to the change in weight of the receptacle and the waste the receptacle contains in a linear relationship.

Another embodiment of the invention relates to a method for monitoring waste material in a waste containment device which comprises determining weight of the waste material; electronically detecting an occurrence of a triggered event associated with the waste material within the containment device and transmitting the data thus collected; identifying the location of the containment device by global positioning system; and receiving, storing, and associating the data transmitted on a remote server network via wireless transmission.

In this method, a management module is included to periodically receive and transmit waste container data collected from the weighing device. The computer server network further receives, stores, and associates identifying information with the containment device, including at least one of a street address where the device is located or a name of a restaurant or customer associated with the device.

The said server generally records a time at which the waste container is emptied for waste collection and is configured to receive, store, and transmit global positioning data from the global positioning device.

Another method of the invention is for acquiring and transmitting waste material data for waste collection. This method comprises generating waste material data; calculating optimization ratio of waste material to waste container from the collected waste material data; modifying the waste material data generated; processing the waste material data generated; and outputting the processed waste material data to a remote server via wireless transmission.

In this method, the generating of the waste material data is acquired by a weighing device that determines the weight data of the waste material in the waste container. Any of the measuring devices mentioned herein can be used for this purpose. When using ultrasound, the method further includes adjusting an ultrasound beam according to the density of the waste material accumulated within the waste container.

Preferably, the ultrasound method includes buffering data from a data acquisition device at substantially the same time or in real time as the data is acquired by the data acquisition device. Also, the calculating of an optimization ratio of waste material to waste container includes transmitting waste material data to a management system which modifies the waste material data that is generated. The management system also processes the data generated and outputs the processed waste material data to a customer computer.

Another embodiment of the invention is a system for managing waste material comprising an enclosure that stores waste material undergoing fermentation; a fermentation mechanism that dispenses a predetermined amount of microorganism for fermenting the material in the enclosure; a weighing device that determines the weight data of the waste material; and a management module that detects occurrence of a triggered event associated with the waste material within the enclosure.

The enclosure generally has an access through which the waste material can be introduced into the enclosure and through which the waste material can be removed from the enclosure. Preferably, the enclosure includes a removable, air-tight, and water-impermeable cover. The fermentation mechanism advantageously includes a container and at least one valve to disperse the microorganism into the waste material at a predetermined temperature for a predetermined period of time. The weighing device can include a memory for storing the weighing data, while the management module processes the weighing data and determines a waste material collection time based on the weighing data and a schedule associated with the collection of waste material from a plurality of waste collection locations.

As shown in FIG. 1, in an embodiment of the present invention, the dumpster for organic waste includes a receptacle 100, a weight sensor 105, a pump 115, and a reservoir 120 for holding a fluid of microorganisms. This embodiment of the invention functions to provide an efficient method of disposing of organic waste by an automated fermentation process, thereby reducing odors and preventing rotting of waste products. In this embodiment of the invention, the weight sensor 105 detects the amount of waste added to the receptacle 100. Depending on the amount of waste added to the receptacle 100, a pump 115 is activated for various amounts of time and functions to pump fluid containing microorganisms from the reservoir 120 to the top of the receptacle 100 where it is dispersed over the added waste. This ensures that an appropriate amount of microorganisms are automatically added to the waste and can digest the waste by fermentation, thereby minimizing odors and preventing rotting. Among other applications, this embodiment of the invention will be of particular use in the restaurant industry where significant amounts of food waste is generated for disposal.

In this embodiment of the invention, the receptacle 100 functions to hold the organic waste while it is being digested by fermentation. The receptacle 100 most preferably contains a volume of 0.25 to 10 cubic yards. The portion of the receptacle 100 in contact with the waste is preferably composed of a non-corrodible material, such as plastic or stainless steel. In a preferred variation of the embodiment, the entire receptacle 100 is composed of non-corrodible material. A receptacle 100 made of plastic can be formed from injection molding or similar techniques. In an alternate variation, the receptacle 100 is composed of steel, aluminum, or another metal alloy, with an inner coating of non-corrodible material, such as plastic. In some variations, the dumpster contains wheels 145 to enable moving the dumpster. In one variation, the wheels 145 contain the weight sensors 105 to assist in determining the weight of the contents.

In the first embodiment of the invention, the weight sensor 105 functions to measure the amount of waste added to the dumpster. In a preferred variation of the embodiment, the weight sensor 105 is an electric sensor, such as a piezoelectric sensor. In an alternate variation, the weight sensor 105 is a pressure sensor. In a preferred variation, the weight sensors 105 are located on wheels 145 attached to the receptacle 100. In an alternate variation, the weight sensor 105 is located at the base of the receptacle 100.

In the first embodiment of the invention, the pump 115 functions to move fluid from the reservoir 120 to the top of the receptacle 100 in response to the addition of waste to the receptacle 100. The amount of activity of the pump 115 is directly proportional to the weight of material added to the receptacle 100, such that the more material added to the receptacle 100, the longer the pump 115 is activated. In one variation of this embodiment, this direct relationship between pump 115 activity and amount of waste is a linear relationship. In an alternate variation, the direct relationship between pump 115 activity and amount of waste is an exponential relationship. The pump 115 can be powered by an electric power source 110 contained on the receptacle, such as by a battery or by solar power, or by an external power source, such as by connection to an electrical outlet. In one variation, activation of the pump 115 results in transport of microorganisms from the reservoir 120 through a supply line 130 towards the top of the receptacle 100. The microorganisms are then distributed over the waste through a dispersing mechanism 135. In a preferred variation, this dispersing mechanism 135 is a misting nozzle. In an alternate variation, the dispersing mechanism 135 dispenses a stream of liquid containing microorganisms. In another alternate variation, the dispersing mechanism 135 drips the liquid containing microorganisms into the receptacle 100.

In the first embodiment, the reservoir 120 functions to store microorganisms capable of fermenting organic waste. In a preferred variation of the embodiment, the reservoir 120 is adapted to contain a liquid inoculant of microorganisms. The liquid inoculant contains yeast, bacteria, or a mixture of both microorganisms that are capable of fermentation. In one variation, the inoculant is EM•1® Effective Microorganisms® manufactured by TeraGanix®. In one variation, the reservoir 120 is connected to a volume sensor 125, which indicates the amount of fluid present in the reservoir 120 or when the reservoir 120 needs to be refilled.

As shown in FIG. 2-4, a variation of this embodiment further includes a sealable lid 140. This variation can further include a seal sensor 150 to indicate when the lid 140 is sealed closed (FIG. 2) and when the lid 140 is open (FIG. 3). The sealable lid 140 can function to provide an anaerobic environment for fermentation, reduce odors, keep out rodents, protect against weather, and/or to signal when to dispense microorganisms over the waste material. In a preferred variation of the embodiment, the lid 140 contains the dispersing mechanism 135. In a preferred variation of the embodiment, the seal sensor 150 indicates when the lid 140 switches from an open to a closed state and signals to the weight sensor 105 to measure the change in weight of the waste that occurred between the previous closed state and the current closed state, which then activates the pump 115 in response to this change in weight of the waste. In a preferred variation of the embodiment, the pump 115 is only activated when the seal sensor 150 indicates that the lid is in a closed state. In one variation, the lid 140 further contains a device to enable less effort to open the lid 140 or to maintain the lid 140 in an open state, such as a hydraulic piston, pulley system or counter weight.

In some variations, this embodiment of the invention can further include additional sensors 155 for measuring various parameters of the internal receptacle conditions. These sensors 155 may include sensors to measure the temperature or humidity inside the receptacle 100 or the pH of the waste material. In a preferred variation, these sensors 255 further alter the activity of the pump 115 to optimize the amount of microorganisms delivered to the waste material.

This embodiment of the invention can further include a heating element or an insulator to prevent the waste material or microorganism mixture from freezing.

As shown in FIG. 5, in the second embodiment of the present invention, the dumpster includes a receptacle 200, a volume sensor 205, a microcontroller 210, and a device 215 that communicates information collected from the volume sensor 205 and microcontroller 210 via a wireless network 220 to a receiving party 225. The embodiment of this invention functions to provide a means of route optimization for waste disposal. In this embodiment of the invention, the volume sensor 205 collects information regarding the amount of waste contained in the receptacle 200. This volume information is then collected and aggregated by the microcontroller 210 and can then be transmitted via a wireless network 220 to a receiving party 225, such as a waste disposal service. This enables the receiving party 225, such as a waste disposal service, to know when a dumpster is full and ready for pick-up and information regarding the rate of change in waste volume can enable the receiving party 225 to predict when a pick-up will likely be needed. This embodiment of the invention enables a receiving party 225, such as a waste disposal service, to pick-up dumpsters only when they are full, minimizing excess pick-ups and thereby cutting down on costs.

In the second embodiment of the invention, the receptacle 200 functions to hold the waste until it is ready for pick-up by a waste disposal service 225. The receptacle 200 most preferably contains a volume of 0.5-10 cubic yards. The portion of the receptacle 200 in contact with waste is preferably composed of a non-corrodible material, such as plastic. In a preferred variation of the embodiment, the receptacle 200 is composed of non-corrodible material, such as plastic. The receptacle 200 of this variation can be formed from injection molding. In an alternate variation, the receptacle 200 is composed of steel, aluminum, or another metal alloy, with an inner coating of non-corrodible material, such as plastic. In some variations, the dumpster contains wheels 230 to enable moving the dumpster.

In the second embodiment of the invention, the volume sensor 205 functions to measure the volume of waste in the receptacle 200, thereby indicating the fullness of the receptacle 200. In one variation of the invention, the volume sensor 205 is located at the top of the receptacle 200, near the opening. In a preferred variation, the volume sensor 205 uses ultrasound to determine the volume of waste in the receptacle 200. In an alternate variation, the volume sensor 205 uses optics to determine the volume of waste in the receptacle 200. In one variation of the embodiment, the volume sensor 205 measures the volume of waste present in the receptacle 200 at a predetermined, and possibly variable, interval such as every hour or continuously.

In the second embodiment of the invention, the microcontroller 210 functions to collect and aggregate information from the volume sensor 205. The microcontroller 210 uses an algorithm to aggregate information about the volume of waste present in the receptacle 200 to provide information about the current level of waste in the receptacle 200. In one variation, the microcontroller 210 uses an algorithm to aggregate information about the volume of waste present in the receptacle 200 over time to provide information about the rate of waste accumulation in the receptacle 200. In one variation of the embodiment, the microcontroller 210 does not store collected information on the dumpster itself, but instead, transmits the information to the device 215 that communicates via a wireless network 220 to a receiver 225. In an alternative variation, the microcontroller 210 is capable of storing collected volume information in a memory device on the dumpster.

In the second embodiment of the invention, the device 215 that communicates information collected from the volume sensor 205 and microcontroller 210 via a wireless network 220 functions to transmit information about the current volume of waste in the receptacle 200 or the rate of waste accumulation in the receptacle 200 to a receiver 225 via a wireless network 220. In a preferred variation of the embodiment, the wireless network 220 used to transmit the data to a receiver 225 is external to the dumpster and maintained independently of the dumpster. In one variation of the embodiment, the device 215 communicates the information from the dumpster via electronic mail to the receiving party 225. In an alternate variation of the embodiment, the device 215 communicates the information from the dumpster to route optimization software on the receivers computer. In a preferred variation of the embodiment, the receiving party 225 is a waste disposal service and the information communicated indicates that the dumpster is full and ready for pick-up or indicates the current rate of waste accumulation so a pick-up time in the future can be estimated.

As shown in FIG. 6, a variation of the second embodiment further includes a sealable lid 235. This variation can further include a seal sensor 240 to indicate when the lid 235 is sealed closed and when the lid 235 is open. In a preferred variation of the embodiment, the lid 235 contains the volume sensor 205. In a preferred variation of the embodiment, the seal sensor 240 indicates when the lid 235 switches from an open to a closed state and signals to the volume sensor 205 to measure the change in volume of the waste that occurred between the previous closed state and the current closed state. The information is then collected and aggregated by the microcontroller 210. In one variation, the lid 235 further contains a device to enable less effort to open the lid or to maintain the lid in an open state, such as a hydraulic piston, pulley system or counter weight.

As shown in FIG. 7, in the third embodiment of the present invention, the dumpster for organic waste includes a receptacle 300, a weight sensor 305, a reservoir for holding a fluid of microorganisms 310, a means for distributing the fluid to the receptacle, a volume sensor 315 to measure the amount of waste in the receptacle, and a means of communicating the information from the volume sensor to a receiving party. This embodiment of the invention combines the features of the previous two embodiments of the invention and functions to provide an efficient method of disposing of organic waste by an automated fermentation process coupled with route optimization for waste disposal. This system functions to reduce odors and prevent rotting using fermentation, thereby allowing waste to be stored for longer periods of time before pick-up. This fermentation process therefore allows waste to be stored until the receptacle 300 is full rather than requiring more frequent pick-ups. Combining the fermentation process with volume sensing and route optimization allows waste to be stored until the volume sensor 315 indicates the receptacle 300 is full and thereby increases efficiency by minimizing the number of pick-up services required to maintain the dumpster. Among other applications, this embodiment of the invention will be of particular use in the restaurant industry where significant amounts of food waste is generated and must be disposed of.

In the third embodiment of the invention, the receptacle 300 functions to hold the organic waste while it is being digested by fermentation. The receptacle 300 most preferably contains a volume of 0.25-10 cubic yards. The portion of the receptacle 300 in contact with waste is preferably composed of a non-corrodible material, such as plastic. In a preferred variation of the embodiment, the receptacle 300 is composed of non-corrodible material, such as plastic. The receptacle 300 of this variation can be formed from injection molding. In an alternate variation, the receptacle 300 is composed of steel, aluminum, or another metal alloy, with an inner coating of non-corrodible material, such as plastic. In some variations, the dumpster contains wheels 320 to enable moving the dumpster. In one variation, the wheels 320 contain the weight sensors 305.

In the third embodiment of the invention, the weight sensor 305 functions to measure the amount of waste added to the dumpster. In a preferred variation of the embodiment, the weight sensor 305 is an electric sensor, such as a piezoelectric sensor. In an alternate variation, the weight sensor 305 is a pressure sensor. In a preferred variation, the weight sensors 305 are located on wheels 320 attached to the receptacle 300. In an alternate variation, the weight sensor 305 is located at the base of the receptacle 300.

In the third embodiment, the reservoir 310 functions to store microorganisms capable of fermenting organic waste. In a preferred variation of the embodiment, the reservoir 310 is adapted to contain a liquid inoculant of microorganisms. The liquid inoculant contains yeast, bacteria, or a mixture of both microorganisms that are capable of fermentation. As noted above, the preferred inoculant is EM•1® Effective Microorganisms® manufactured by TeraGanix®. In one variation, the reservoir 310 is connected to a volume sensor 315, which indicates the amount of fluid present in the reservoir 310 or when the reservoir 315 needs to be refilled.

In the third embodiment, the means for distributing the fluid of microorganisms to the receptacle 300 functions to add microorganisms to the interior of the receptacle 300 in response to the addition of waste to the receptacle 300. In one variation of the embodiment, this is accomplished using a pump 325. In this variation, the pump 325 functions to move fluid from the reservoir 310 to the top of the receptacle 300 in response to the addition of waste to the receptacle 300. The amount of activity of the pump 325 is directly proportional to the weight of material added to the receptacle 300, such that the more material added to the receptacle 300, the longer the pump 325 is activated. In one variation of this embodiment, this direct relationship between pump 325 activity and amount of waste is a linear relationship. In an alternate variation, the direct relationship between pump 325 activity and amount of waste is an exponential relationship. The pump 325 can be powered by a power source contained on the receptacle 300, such as by a battery or by solar power, or by an external power source, such as by connection to an electrical outlet. In one variation, activation of the pump 325 results in transport of microorganisms from the reservoir 310 through a supply line 330 towards the top of the receptacle 300. The microorganisms are then distributed over the waste through a dispersing mechanism 335. In a preferred variation, this dispersing mechanism 335 is a misting nozzle. In an alternate variation, the dispersing mechanism 335 dispenses a stream of liquid containing microorganisms. In another alternate variation, the dispersing mechanism 335 drips the liquid containing microorganisms into the receptacle.

In the third embodiment of the invention, the volume sensor 315 functions to measure the volume of waste in the receptacle 300, thereby indicating the fullness of the receptacle 300. In one variation of the invention, the volume sensor 315 is located at the top of the receptacle 300, near the opening. In a preferred variation, the volume sensor 315 uses ultrasound to determine the volume of waste in the receptacle 300. In an alternate variation, the volume sensor 315 uses optics to determine the volume of waste in the receptacle 300. In the preferred variation of the embodiment, the volume sensor 315 measures the volume of waste present in the receptacle 300 at a predetermined, and possibly variable, interval such as every hour or continuously.

In the third embodiment of the invention, the means of communicating the information from the volume sensor 315 to a receiving party 340 functions to transmit information about the current volume of waste in the dumpster or the rate of waste accumulation in the dumpster to a receiver 340 via a wireless network 345. In one variation of the embodiment, the information from the volume sensor 315 is collected and aggregated by a microcontroller 350. The microcontroller 350 uses an algorithm to aggregate information about the volume of waste present in the receptacle 300 to provide information about the current level of waste in the receptacle 300. In one variation, the microcontroller 350 uses an algorithm to aggregate information about the volume of waste present in the receptacle 300 over time to provide information about the rate of waste accumulation in the receptacle 300. In one variation of the embodiment, the microcontroller 350 does not store collected information on the dumpster itself, but instead transmits the information to the device 355 that communicates via a wireless network 345 and the information is transferred via a wireless network 345 to a receiver 340. In an alternative variation, the microcontroller 350 is capable of storing collected volume information in a memory device on the dumpster. This variation can further contain a device 355 that communicates information collected from the volume sensor 315 and microcontroller 350 via a wireless network 345 which functions to transmit information about the current volume of waste in the receptacle 300 or the rate of waste accumulation in the receptacle 300 to a receiver 340 via a wireless network 345. In a preferred variation of the embodiment, the wireless network 345 used to transmit the data to a receiver 340 is external to the dumpster and maintained independently of the dumpster. In one variation of the embodiment, the device 355 communicates the information from the dumpster via electronic mail to the receiving party 340. In an alternate variation of the embodiment, the device 355 communicates the information from the dumpster to route optimization software on the receiver's computer. In a preferred variation of the embodiment, the receiving party 340 is a waste disposal service and the information communicated indicates that the dumpster is full and ready for pick-up or indicates the current rate of waste accumulation so a pick-up time in the future can be estimated. In one variation, the reservoir 310 is connected to a volume sensor 360, which indicates the amount of fluid present in the reservoir 310 or when the reservoir 310 needs to be refilled. In an additional variation, The pump 325 connected to reservoir 310 can be powered by an electric power source 365 contained on the receptacle, such as by a battery or by solar power, or by an external power source, such as by connection to an electrical outlet.

As shown in FIGS. 8-10, a variation of the third embodiment further includes a sealable lid 370. This variation can further include a seal sensor 375 to indicate when the lid 370 is sealed closed (FIG. 8) and when the lid 370 is open (FIG. 9). The sealable lid 370 can function to provide an anaerobic environment for fermentation, reduce odors, and/or to signal when to dispense microorganisms over the waste material. In a preferred variation of the embodiment, the lid 370 contains the mechanism for dispersing 335 microorganisms to the waste. In a preferred variation of the embodiment, the seal sensor 375 indicates when the lid 370 switches from an open to a closed state and signals to the weight sensor 305 to measure the change in weight of the waste that occurred between the previous closed state and the current closed state, which then activates the pump 325 in response to this change in weight of the waste. In a preferred variation of the embodiment, the pump 325 is only activated when the seal sensor 375 indicates that the lid 370 is in a closed state. In a preferred variation of the embodiment, the lid 370 contains the volume sensor 315. In a preferred variation of the embodiment, the seal sensor 375 indicates when the lid 370 switches from an open to a closed state and signals to the volume sensor 315 to measure the change in volume of the waste that occurred between the previous closed state and the current closed state. The information is then collected and aggregated by the microcontroller 350. In one variation, the lid 370 further contains a device to enable less effort to open the lid 370 or to maintain the lid 370 in an open state, such as a hydraulic system.

In some variations, this embodiment of the invention can further include additional sensors 380 for measuring various parameters of the internal receptacle conditions. These sensors 380 can include sensors 380 to measure the temperature or humidity inside the receptacle or the pH of the waste material. In a preferred variation, these sensors 380 further alter the activity of the pump 325 to optimize the amount of microorganisms delivered to the waste material.

This embodiment of the invention can further include a heating element or an insulator to prevent the waste material or microorganism mixture from freezing.

As shown in FIGS. 11-12, the method 400 of the fourth embodiment includes generating waste material data, calculating optimization ratio of waste material to waste container from the collected waste material data, processing the waste material data generated, and outputting the processed waste material data. The method 400 functions to use sensors to optimize the data for waste material processing in real-time. Steps S410 have several alternatives or additional sub-steps that preferably affect the generation of waste material data for processing. In a first variation, Step S410 includes collecting at least one sensor data to acquire waste material data for processing. The method also includes calculating weight, volume, and inoculant fluid level of the processed waste through a microcontroller that processes the waste material raw data. The microcontroller then transmits to a remote server the waste material data processed. In a second variation waste material data collected from sensors are directly transmitted to a remote server that processes the waste material data and in turn feeds back to the microcontroller for additional storage of data.

Step S410 includes generating waste material data, and more specifically, acquiring waste material data. Step S410 preferably includes the alternative or sub-steps of collecting and preparing such data. The step of collecting data functions to collect raw waste material data such as from a weight, volume, density or inoculant fluid level sensor. The waste material data acquisition device, such as an ultrasound transducer, preferably has control inputs that determine the manner of waste material data collection. The data collection is preferably controlled by at least one microcontroller, which transmits and receives sensor signals. The raw data may be represented in different forms or any suitable representation of raw waste material data. Preparing waste material data functions to convert raw data into a more readily accessible and processed form. The acquired waste material data may alternatively be left as raw data or the acquired data may alternatively be processed in a prepared data format from an outside source. The data is preferably acquired from an ultrasound device, but may alternatively be any suitable data acquisition system that is sensitive to motion and change in environment. Alternatively, the acquired data may be provided by an intermediary device such as a hard drive or any suitable device. The preferred embodiment generating waste material data may include additional sub-steps such as steps to modify, buffer, or organize the acquired data.

Step S420, which includes calculating optimization ratio of waste material to waste container from the acquired and processed waste material data, and any other motion that affects the acquired area. Sensors detect change in material weight, volume, density and inoculant fluid level. The measured motion of sensors may be a measurement of weight, inoculant fluid level, weight, density, velocity, acceleration, waste fermentation decay rate, ph, temperature, humidity, moisture, or sulfur content. Optimization ratio is preferably calculated using the raw data, but may alternatively use any suitable form of waste material data. At least two different data sets acquired at different times are preferably used to calculate the optimization rate of waste material to waste container over a scheduled time period. The optimization ratio may additionally be improved and refined using models of inoculant fluid level to detect waste material disposal patterns.

Step S430, which includes processing waste material data, functions to transfer the acquired waste material data for analysis, scheduling of waste collection, or any other suitable goal. The step of processing preferably aids in the detection of waste material container fullness. After the processing of the waste material is complete, the method preferably proceeds to outputting the processed data. The outputted data may be used for any suitable operation such as being transmitted to another device, stored, displayed, or any other suitable use. Preferably Step S430 uses the data that generated in Step S410 and calculated in Step S420. Step S430 is preferably performed in real-time while the waste material data is acquired, but may alternatively be performed offline or remotely on saved, buffered data, or any other suitable method.

Step S416, which includes forming data, functions to synthesize waste material data for waste collection processing and eventual data outputting to waste haulers for waste disposal collection. The waste material data formation is preferably generated from the acquired or prepared waste material data.

Step S432, which includes adjusting sensors, functions to adjust settings of a waste material data acquisition device based on the acquired processed raw data. The sensors are preferably altered according to the calculated waste data to dispense a predetermined amount of microorganisms or yeast capable of fermentation in the waste container for the purpose of fermentation. Adjusted data are preferably communicated to the sensors for implementation. Additionally, the user may manually change the waste material data based on acquired data.

As shown in FIG. 13, the method 500 of the fifth embodiment includes determining the weight data of the waste material, detecting occurrence of a triggered event associated with the waste material within the enclosure and transmitting the waste container data collected, identifying the waste container using an identification mechanism, locating the waste container using a global positioning device, and receiving and transmitting waste container data. The identification mechanism alternatively can be a standard radio frequency identification tag or barcode, which can be scanned manually or sent to the microcontroller to be outputted to a remote server. The method 500 functions to use waste monitoring system to detect waste container fullness to improve waste collection efficiency.

Step S510, which includes identifying a waste container associated and assigned to a user. Step S510 includes identifying a waste container to be deployed. Step S510 preferably includes associating a unique identification number with a particular waste container. The step of identifying a waste container functions to collect data for efficient waste collection when waste container is full. The unique identification number may be populated with additional data, such as, but not limited to asset purchase data, asset type, asset value, billing information and contract data.

Step S518, which includes the microcontroller receives data from sensors that detect weight, volume, and inoculant fluid level. The microcontroller preferably consolidates the waste material data generated from the sensors and outputs them to a remote server through wireless transmission of data. Alternatively the transmission of data can be made through other telecommunication device or any other suitable device. The remote server aggregates the data of the waste container. In addition, the remote server processes data on total volume, percentage volume, total weight, total number of pickups, and timestamp of activity. Additionally, the remote server processes a fullness prediction output based on the aggregated data. Alternatively output includes waste production of nearby business, waste production of similar businesses, customer historical waste production, or economic indicators. The route optimization output functions to increase efficient waste disposal collection by inputting off-the-shelf route optimization software. Alternatively the route optimization output can use Drive Route, Fleet Mind, or any other suitable software or hardware, not excluding excel database, email and web-based interfaces.

Step S520 to Step S522, includes the global positioning device identifying and locating the waste container. The identification mechanism is read by an identification reader and stored in both the microcontroller and the remote server. The remote server associates the global positioning data acquired to the data acquired by the identification reader. Additionally the date and time of installation, weight, density, total volume, percentage volume, and total number of pick up and timestamp of activity is determined through the waste material data processed. Alternatively, the microcontroller may transmit data to a data buffer device after a plurality of waste containers have been deployed. The data associated with each waste container may be stored in the remote server database for a predetermined period of time.

Step S528, which includes the remote server transmitting a verification message to the microcontroller to indicate that the information has been received and updated. The verification is transferred via wireless link or alternatively, via cellular modem, cellular infrastructure, or any suitable device.

As shown in the FIGS. 14-15, the system 600 of the sixth embodiment includes an enclosure that stores waste material undergoing fermentation, a fermentation mechanism that dispenses an effective amount of microorganisms and/or yeast capable fermentation into the enclosure, a weighing device that determines the weight of the waste material, and a management module that detects occurrence of a triggered event associated with the waste material within the enclosure. The system functions to ferment the waste material, weigh the waste material, and signal the waste management system when a threshold level has been exceeded. The collection service is informed to service only those waste containers that are full. The system further describes said enclosure having a microcontroller 610 connected to a weight sensor 620, volume sensor 630 and a variety of other sensors 640 including pH, temperature, humidity and other similar sensors. The microcontroller communicates wirelessly with a remote server containing a database 650 which stores data. The remote server processes the data as described in S518. The processed data can be used for billing output 680 when combined with waste hauler rates. Also alternatively, off-the-shelf billing software may be used such as Quicken, Excel, or any other suitable software. Fullness prediction output 660 and route optimization output 670 based on the database data stored on remote server are as described previously herein.

As shown in FIGS. 16-17, in another embodiment, an enclosure(s) 700 that can be affixed to a container 705, has a volume containing multiple components: sensor(s)710, microprocessor(s)715, transmission device(s)720, power source(s) 725 and security device(s)730. The enclosure is resistant to environmental elements such as rain, snow, cold, heat, shock, vibrations, impact and secure from tampering for the means of protecting the enclosure and it's contents. In other embodiments, any combination of these components may exist outside of said enclosure.

In this embodiment, the enclosure(s)700 is made from, or the combination of, corrosion and impact resistant materials such as plastic, stainless steel, coated metal or metal alloy.

In this embodiment, components 710, 715, 720 and 725 are affixed to a single enclosure 700, which is then affixed to container 705. In other embodiments said enclosure could be said container and said components would be incorporated directly into the container. Alternatively, all electronic components could be incorporated directly into the lid or body of the container.

In this embodiment, the said enclosure(s) is comprised of three parts, a baseplate 735, shell 740 and gasket 745. In this embodiment said enclosure is assembled using fasteners such as screws, bolts and/or adhesives. In other embodiments, said enclosure(s) may be comprised of one or more parts.

Waste materials according to this invention can be of solid or liquid materials. Preferably, the solid materials are flowable, such as various chemical entities in powder form, sand or grain. The enclosure is appropriately sized for the amount of material to be accommodated therein to provide for reasonable collection times.

In this embodiment, container 705 conveniently may be an standard 55-gallon oil drum with a removable lid. In other embodiments said container can be a dumpster, silo, pipe, tank, tube, tote, trailer, refrigerator, storage unit, tunnel, wire or transmission line designed to hold or transport materials which are static or kinetic.

In this embodiment, said waste material inside container 705 is a waste oil. In other embodiments, said material can be one, or the combination of, waste such as municipal solid waste and organic waste, recyclables such as paper, plastic and metal, commodities such as grain, petrochemicals, biofuels, and soil amendments, and in general flowable liquids and flowable and non-flowable solids.

In this embodiment, sensor(s)710 is an ultrasound sensor within enclosure 700 and is used to measure the distance from the lid of container 705 to a static material's surface within said container to determine said material's volume. In other embodiments, optics or other similar technologies could be used to determine the material's volume.

In this embodiment, sensor(s)710 is a single sensor. In other embodiments, multiple sensors can be used to determine one or many physical or chemical characteristics of a given material(s) such as volume, density, weight, pH, viscosity, temperature, flow rate, pressure or voltage. Any of the foregoing sensors or sensor combinations can be used.

In addition to determining when the enclosure is full or near filled, the properties of the waste material can be determined by measuring density, pH or temperature. This can be used to send data to inform the collector or data processing party as to the quality or content of the waste material. This can determine more accurately the value of the waste material based upon such properties e.g., to determine a billing charge. It also can allow the collector or waste hauler to identify waste materials for collection that have similar properties so that like materials can be collected together, thus avoiding additional purification steps or similar processing operations that would be required for mixed waste materials.

As shown in FIGS. 17-18, in this embodiment there is a security device(s) 730 which may be an RFID within enclosure 700 used to authorize changes in said material's volume for the purpose of preventing material from being added to or removed from container 705 without authorization. Said security device interfaces with an external wireless key, tag or chip 750 to determine authorization.

It is also contemplated by this invention that the security device may also be a smart card that is swiped or scanned at the enclosure to allow the removal or addition of waste material. In another embodiment, the security device may be an app on a smart phone that communicates with transmission device to send a message that an authorized removal or addition is being made. In other embodiments, security device(s)730 could be a physical key, fingerprint, retinal scan, PIN number entry on keypad, pattern lock, infrared remote or other similar device.

In this embodiment, if an increase or drop in material level, outside of an acceptable measurement error range, without said authorization action described above occurs in said container, an alert is triggered. Said alert is sent to the appropriate entity(s) to respond based on geographic location and time. Said appropriate entity(s) may include the waste hauler, an agent of the waste hauler, owner of said container, the police, private security or a combination of all or any of these entities.

In other embodiments an audio alarm can be activated, at the location of the container, to draw attention to the perpetrator.

In other embodiments a tracking device(s) can be released into a material being stolen so the load of stolen material can be traced remotely. For example, if a tracking device is released into a waste restaurant grease storage container it will be sucked into the tank a perpetrator is loading the grease into.

In other embodiments ink or dye that stains can be released onto the perpetrator to easily identify them.

In addition, this embodiment acts as a visual cue to potential perpetrators that the container is under surveillance—influencing their decision to add or remove material from the container without authorization.

Further, from a remote location this embodiment is able to recognize theft patterns in real-time, predict which containers are most likely to experience subsequent illegal activity and alert the said appropriate entity(s). Using historical data, this embodiment can also predict theft in advance of a trigger event occurring and alert the said appropriate entity(s)

In this embodiment, a transmission device(s)720 within enclosure 700 is used to wirelessly send the data from the location of data collection to a remote location. In other embodiments, said transmission device(s) could be hardwired.

As shown in FIG. 18, in this embodiment, microprocessor(s)715 within enclosure 700 is connected to sensor(s)710, transmission device(s)720 and security device(s)730 and runs a software program to control said sensor(s) and device(s) for the purposes of collecting and outputting data.

In this embodiment, the software program running on microprocessor(s) 715 has two-way communication with an external server(s)755 at a periodic interval. In this embodiment, said server stores data in a database(s)760. The server may also communicate with said microprocessor to provide software updates, run maintenance tests or other tasks. Data in said database, stored on said server, is processed and presented in a user interface 765 for purpose of security and analytics. Information shown in said user interface may be all or a select subset of the said data stored in said database. Said user interface can be accessed by any web-enabled device such as a computer, smartphone, tablet, or other similar product.

In this embodiment, users accessing the user interface may participate in the removal of said material from said container or alternatively the replenishment of said material in said container.

The data may be received by a waste collector or a third party who first processes the data before providing it to the waste collector. The data that is transmitted includes a unique identifier of the location of the enclosure so that a pickup route can be determined based on the receipt of multiple data messages from different waste enclosures.

In this embodiment, the analytics provided to the user via said interface are a combination of metrics on each container 705 being tracked by the user. These metrics can include the current volume level of material in each said container, the current percent fullness or emptiness of each said container, and the location of each said container, aggregated onto a visual map, chart or statement. Current metrics for each said container may also be presented along with historical metrics. Trigger events described previously herein may be shown in this user interface as a visual indication on the user interface such as a color change of the triggered container, rearrangement of triggered container to priority at the top of a list, audible alert or a combination of all or any of these.

The data that is provided can also be analyzed to determine a predictive pickup based on the rate of collection of the waste material to further assist the waste collector or hauler to determine when a pickup may need to be made. For example, if a particular enclosure is continuously being filled every four days, then a collection can be scheduled at that interval. While it is desirable to have the enclosed collected when it is as full as possible, the collection should be made before a complete filling in order to avoid overfilling of the enclosure. Thus, a collection can be scheduled after receiving a message that the enclosure is at least 75% full by volume. Of course, better economies are achieved if the collector arrives after the enclosure is 80%, 85%, 90% or even 95% full by volume or when the enclosure is predicted to be at those fill levels. This avoids the situation where an enclosure that is only half full or less is being inefficiently accessed for collection of the waste material.

The same system can be used for the replenishment of liquid or solid materials by sending messages as to when the enclosure is near being empty. Thus, a replenishment delivery can be scheduled after receiving a message that the enclosure is only 25% full by volume. Of course, better economies are achieved if the delivery is made after the enclosure is only 20%, 15%, 10% or even 5% full by volume or when the enclosure is predicted to be at those fill levels. Of course, one should not wait until the enclosure is nearly completely empty as this may cause disruption of the customer's business due to the lack of sufficient material.

Additionally, the data from enclosures in a given geographic location and/or similar business type can be aggregated for the purpose of making general predictions of waste production, security risk and economic performance within said geography or industry. The waste production and security risk of a given geography and/or business type can also be used to extrapolate more accurately the waste production, security risk and economic performance for a single, specific business or subset of businesses.

In other embodiments records of said data can be aggregated and presented to government, research, public interest, public safety, marketing and/or sales organizations either for sale or as a donation.

In this embodiment, the power source(s)725 within enclosure 700 is a battery. In other embodiments, said power source(s) could be a wired power transmission line, solar cell or any other electric power supply.

As a person skilled in the art of waste disposal will recognize from the previous detailed description and from the figures and claims, modifications and changes can be made to the preferred embodiments of the invention without departing from the scope of this invention defined in the following claims.

As a person skilled in the art will recognize from the previous detailed description and from the figures and claims, modifications and changes can be made to the preferred embodiments of the invention without departing from the scope of this invention defined in the following claims.

We claim:

1. A method for scheduling waste material removal, comprising:
receiving waste material information for each of a set of containers, each container comprising a sensor and configured to contain waste material, the waste material information based on a sensor measurement by the sensor;
identifying contents of the waste material contained within each of the set of containers based on the respective waste material information; and
determining a collection schedule for the set of containers based on the contents of the waste material for each of the set of containers.

2. The method of claim 1, wherein determining a collection schedule based on the contents of the waste material for each of the set of containers comprises:
determining a measure of content mixing for each container; and
determining the collection schedule based on the measure of content mixing.

3. The method of claim 2, wherein determining the collection schedule further comprises determining the collection schedule based on a waste material volume of each container.

4. The method of claim 3, further comprising determining the waste material volume of each container based on the waste material information.

5. The method of claim 2, wherein determining a collection schedule based on the contents of the waste material for each of the set of containers further comprises selecting a disposal vehicle based on the measure of content mixing.

6. The method of claim 5, wherein determining a collection schedule for the set of containers further comprises determining a route for the disposal vehicle based on the contents of the waste material for each of the set of containers.

7. The method of claim 6, wherein determining a route for the disposal vehicle based on the contents of the waste material for each of the set of containers comprises selecting a subset of the containers based on the respective measure of content mixing and determining a route for the disposal vehicle based on locations associated with each of the subset of containers.

8. The method of claim 1, wherein the sensors for each of the set of containers comprise optical sensors, wherein the waste material information comprises an image recorded by the optical sensor.

9. The method of claim 8, wherein identifying the contents of the waste material comprises analyzing the image to determine the contents of the waste material.

10. The method of claim 1, wherein determining a collection schedule based on the contents of the waste material for each of the set of containers comprises:
determining a value of the waste material contained in each container based on the respective contents of the waste material; and
determining the collection schedule based on the value.

11. The method of claim 1, wherein receiving waste material information for each of a set of containers comprises receiving waste material in response to sensor measurement.

12. The method of claim 11, wherein the sensor measurement is recorded in response to vibration above an acceleration threshold.

13. The method of claim 11, wherein the sensor measurement is recorded in response to container lid actuation.

14. A method for scheduling waste removal from a set of containers, each container including a sensor, the method comprising:
receiving waste material information for each of the set of containers, the waste material information based on a measurement of the respective sensor;
identifying contents of waste material contained in each of the set of containers based on the respective waste material information;
determining a value for each container based on the respective contents of the waste material contained in the container; and
determining a collection schedule based on the values of each container.

15. The method of claim 14, wherein the value is based on a measure of content mixing within the container.

16. The method of claim 14, wherein determination the value for each container further comprises:
determining a quality of a piece of content within each container based on the respective waste material information; and
determining the value for the container based on the respective quality of the waste material.

17. The method of claim 14, wherein determining the collection schedule further comprises:
determining a volume of waste material in each container of the set; and
determining the collection schedule based on the respective volume of waste material.

18. The method of claim 17, wherein determining the collection schedule based on the respective volume of waste material comprises selecting containers having a volume of waste material exceeding a volume threshold for inclusion in the collection schedule.

19. The method of claim 18, wherein determining the collection schedule comprises selecting containers having similar waste material content for inclusion in the collection schedule.

20. The method of claim 17, wherein the sensor comprises an optical sensor, wherein the waste material information comprises an image, and wherein determining the volume of waste material comprises determining the volume of waste material based on analysis of the image.
